(19) United States
(12) Patent Application Publication
(10) Pub. No.: US 2009/0019362 A1
(43) Pub. Date: Jan. 15, 2009

(54) Automatic Reusable Definitions Identification (Rdi) Method

(76) Inventors: Avri Shprigel, Rishon Lezion (IL); Dane Dannells, Lerum (SE)

Correspondence Address: HAIM FACTOR;Ofek Group Inc., 16192 Coastal Highway, Lewes, DE, 19958, US

(21) Appl. No.: 12/281,626

(22) PCT Filed: Mar. 7, 2007
(86) PCT No.: PCT/IL07/00294

§ 371 Date: Sep. 4, 2008

Related U.S. Application Data
(60) Provisional application No. 60/780,878, filed on Mar. 10, 2006.
(60) Provisional application No. 60/789,599, filed on Apr. 6, 2006.
(60) Provisional application No. 60/856,836, filed on Nov. 6, 2006.

(51) Int. Cl. G06F 17/21

(52) U.S. Cl. 715/256

(57) ABSTRACT

Disclosed is a linguistically-based method for searching and recommending reusable definition candidates in one or more documents and for calculating measures of reuse efficiency and reuse consistency in these documents. Some embodiments of the present invention also produce document précis, whereby common terms and other data can be replaced by short titles with a link to their description. The definition candidates and the text pr?cis can be used in search engines of large databases or of the internet to provide more valuable and efficient search results. According to additional embodiments of the present invention a tool is provided for aiding individuals with reading disabilities. The tool facilitates document comprehension processes by separating the most valuable text content e.g. the definitions part. Additionally, some embodiments of the present invention enable evaluating the pattern perception of the text writer by statistically measuring the amount of usage of definition candidates.

### FIELD OF INVENTION

The present invention relates in general to the field of textual analysis of electronic documents; more particularly it relates to the field of textual analysis of electronic documents according to syntactic identification of definitions.

### BACKGROUND OF THE PRIOR ART

Using common definitions in multiple documents can enhance writing efficiency and inter-documents consistency that is crucial in software requirement documents. Existing organizations are very conservative about changes in the software development process, and new tools may be adopted cautiously. Integration of a definition management tool can be accelerated if reusable definition candidates are suggested and preliminary quality measurements of existing documents, based on common reusable definitions, are available. A tool which can identify, analyze and extract the definitions provided in existing documents may prove to be useful in additional fields as well.

US Patent Application No. 20060184867 discloses a method for reusing, managing and monitoring definitions in documents. The method suggests using a dedicated process that manages the ‘life cycle’ of the definitions. This process keeps track of each definition version in a dedicated versions tree, state transition process and history/log files functioned to track the changes.

US Patent Application No. 2005234709 discloses a system for automatically generating a dictionary from full text articles, extracts term and definition pairs from full text articles and stores these pairs as dictionary entries. The system includes a computer readable corpus having a plurality of documents therein. A pattern processing module and a grammar processing module are provided for extracting the term and definition pairs from the corpus and storing the pairs in a dictionary database. A routing processing module selectively routes sentences in the corpus to at least one of the pattern processing module or grammar processing module.

Japanese Patent No. 2004287710 discloses a system for realizing highly precise natural language processing by using the definition information of a character string inputted when a document is prepared for natural language processing. This system is provided with a document preparing tool for preparing a document in accordance with a user input, a language processing tool for executing the natural language processing of the descriptive contents of a document and a shared dictionary to be referred to by the document preparing and the language processing. The document preparing tool reflects definition information such as the part of speech of a character string inputted by the user when a document is prepared on the shared dictionary, and the language processing tool executes the natural language processing by referring to the character string definition information reflected on the shared dictionary.

Although there are patents and patent applications that disclose an automatic extraction and replacement of definitions, none of the specified patents and patent applications discloses a method of automatic extraction and replacement of definitions using a differentiation between definitions and actions. There is therefore a need for a definition management tool that extracts definitions from project documentation documents in order to build a terminology dictionary and that further supports the automatic replacement of extracted definitions with the proper terminology.

### SUMMARY OF SOME EMBODIMENTS OF THE INVENTION

The present invention discloses a novel method for organizing definition in documents.

In embodiments of the invention, the method includes the step of scanning segment of texts in the document for definition candidates according to definition rules.

In embodiments of the invention, the method includes the step of scoring each definition candidate according to its correspondence to the definition rules.

In embodiments of the invention, the method includes the step of selecting definition candidates with highest scores.

In embodiments of the invention, the method includes the step of searching for nested definitions for each the segment of text, wherein the segment of text includes at least one definition candidate.

In embodiments of the invention, the definition rules are comprised of at least one of the following: syntactic analysis of phrases, keywords identification, analysis of typographic phrase formatting.

In embodiments of the invention, the syntactic analysis comprises the steps of identifying the tense of the phrase and identifying grammatical characteristics of the phrase.

In embodiments of the invention, the grammatical characteristics include at least one of the following: identifying indicative verbs, identifying indicative phrase components, identifying part of speech, identifying indicative of the segment of text.

In embodiments of the invention, the scoring of definitions are weighted using at least one of the following methods: manually, automatically.

In embodiments of the invention, the automatic method the rules are scored by analyzing existing definitions and extracting the most prevalent definitions phrasing style.

In embodiments of the invention, the existing definitions include at least one of the following: document containing definition candidates, document containing definitions, a definitions library.

In embodiments of the invention, the method includes the step of associating a definition title to each selected definition.

In embodiments of the invention the process of extracting the definition title further comprises the steps of: searching for all noun phrases in the definition; assigning a score to each noun phrase; selecting the noun phrase with the highest score as the definition title.

In embodiments of the invention, the scoring noun phrase is comprised of at least one of the following: sentence order, location of the noun phrase in the sentence, noun phrases frequency across different sentences, noun phrase words content, syntactic pattern, acronym, name entity.

In embodiments of the invention, the scoring of noun phrase is performed by giving weight to title rule.

In embodiments of the invention, the scoring of noun phrase is performed using at least one of the following methods: manually, automatically.

In embodiments of the invention, the automatic method rules are scored by analyzing existing title and extracting the most prevalent title phrasing style.

In embodiments of the invention the method includes the step of creating a list of all definition candidates including the definition title and the definition description.

In embodiments of the invention, the method includes the step of extracting a précis of the texts wherein the précis is a shorter presentation of the original text in which each identified definition is replaced with its definition title.

In embodiments of the invention, the process of extracting the précis includes the steps of searching for all definition candidates; creating a list of all definitions including definition title and definition description; replacing each definition description by its definition title to create the précis; making grammatical corrections in the précis.

In embodiments of the invention, the method includes the step of creating an index in offline mode, by processing data communication network content pages, wherein for each content page the index contains a list of definitions, definition titles and précis text.

In embodiments of the invention, the method includes the steps of enabling the users to conduct searches in the index through a dedicated user interface and displaying to the users at least partial search results.

In embodiments of the invention, displaying includes one of the following: definitions list, précis text.

In embodiments of the invention, the method includes the step of measuring the efficiency and consistency of the texts according to the reuse of definitions in at least one document.

In embodiments of the invention, the documents are organized in a hierarchical structure, wherein child documents inherit parent document definition candidates.

In embodiments of the invention, the method includes the step of automatically compiling a definitions index.

In embodiments of the invention, the definition organization provides users with learning methodologies.

In embodiments of the invention, the method includes the step of evaluating thinking patterns in pattern perception evaluation skills tests on the basis of definition organization.

In embodiments of the invention, the definition is in the form of at least one of the following: text, table, formula, image, figure, text data, flowchart, video clip, hypertext link, Extensible Markup Language (XML) text.

In embodiments of the invention, the method includes the step of providing the user with online definition suggestions during the editing of the text.

In embodiments of the invention the method includes the step of evaluating the text document in accordance with the number of identified definitions in relations to the length of the text document.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a flowchart illustrating the main process in accordance with embodiments of the present invention;

FIG. 2 is a flowchart illustrating the process of searching for definition candidates in a given document in accordance with embodiments of the present invention;

FIG. 3 is a flowchart illustrating the process of searching for a definition title in a segment of a text in accordance with embodiments of the present invention;

FIG. 4 is a flowchart illustrating the process of scoring noun phrases used to select definition title in accordance with embodiments of the present invention;

FIG. 5 is a block diagram illustrating the principle components of the search engine in accordance with embodiments of the present invention;

FIG. 6 is a flowchart illustrating the process of searching for nested definitions in accordance with embodiments of the present invention;

FIG. 7 is a flowchart illustrating the process of producing the précis of a text in accordance with embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### GLOSSARY

Anaphora—using a pronoun to refer to a word or phrase used earlier.
Definition—a definition consists of a definition title and a definition description. The definition title can be used multiple times throughout the document. The definition description part is either linked to the definition title in online electronic documents, or immediately follows the definition title, where all definitions are grouped together. The definition description can contain any combination of definition description elements. It can also contain other definition titles (nested definitions). Definition description elements may contain any word processor elements such as text in any format, data description elements in any format, such as communication protocols, graphic elements, pictures, internet links, numeric formulas, tables, video clips, and the like.
Definition title—a short name representing the definition in the document.
Definition candidate—any data or any description part in the document complying with the definition candidate rules.
Definition candidate score—definition candidates are scored based on definition candidate rules, where each used rule has a score (weight).
Definition candidate rules—rules that are used to find definition candidates in text.
Edit distance—a measure of similarity (distance) between two strings.
Hierarchical documents—parent/child document relationship, whereby the child document relies upon or inherits part or all of the content of the parent document. It can be assumed that at least most of the definitions in the parent document are reused by its children. Hierarchical documents are very common in software specification documentation, where the top-level specification document is supported by several detailed child documents.
Phrasing style—the most frequent definition candidate rules that are used in a specific document, documents of a specific person, project or an organization, in a specific definitions library, and the like.
Phrasing style selection—assigning weights to definition candidate rules, thereby determining the phrasing style. This process can be done manually, or automatically as described below.
Reuse consistency—a measure that is used to compare definitions between documents. When there is an exact match of a definition in two or more documents there is a complete consistency. The consistency can be incremented when a definition is reused, and can be decremented when a definition is not reused.
Reuse efficiency—a measure used to calculate the proportional reduction in document editing size due to definition reuse, see calculation formula in the description section below.

Reuse quality—a measure combining reuse efficiency and reuse consistency.

### DESCRIPTION OF SOME EMBODIMENTS OF THE INVENTION

Disclosed is a linguistically-based method for searching reusable definition candidates in one or more documents and for calculating measures of reuse efficiency and reuse consistency in these documents. Some embodiments of the present invention also produce document précis, whereby common terms and other data can be replaced by short titles with a link to their description. The definition candidates and the text précis can be used in search engines of large databases or of the internet to provide more valuable and efficient search results. According to additional embodiments of the present invention a tool is provided for aiding individuals with reading disabilities. The tool facilitates document comprehension processes by separating the most valuable text content e.g. the definitions part. Additionally, some embodiments of the present invention enable evaluating the pattern perception of the text writer by statistically measuring the amount of usage of definition candidates.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

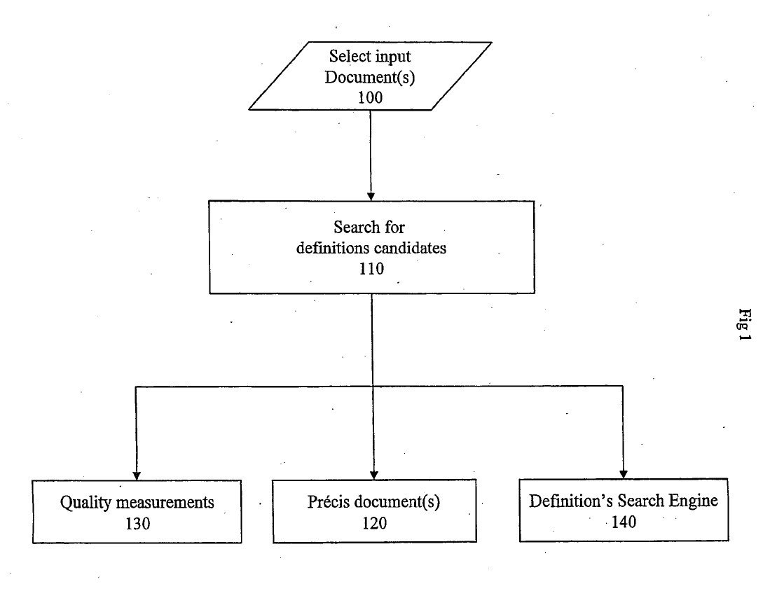

FIG. 1 presents the main linguistically-based processing of texts according to embodiments of the present invention. At the first step (step 100) the input documents are selected. Then, definition candidates are searched for in each of the documents (step 110). Next, three processes may be performed on the selected definition candidates: generating the précis of each document (step 120), measuring the reuse efficiency and reuse consistency of each of the documents (step 130) and preprocessing the text for definition search engine (step 140).

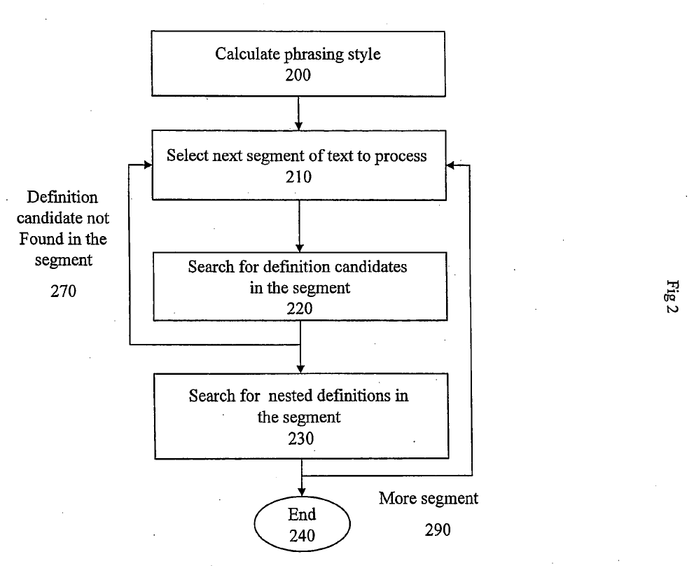

FIG. 2 illustrates the process of searching for definition candidates on segments of text, wherein each segment may contain one or more sentences or other definition components such as figures, tables and formulas. The process optionally includes the following steps. First, phrasing style selection is performed (step 200). Alternatively, step 200 can be performed offline by analyzing various documents or existing definition libraries in the organization. Then the next segment is selected (step 210). See rule DR7 for possible text segmentation. Then the method finds all possible definition candidates in the segment according to the definition candidate rules (step 220). See definition rules DR1-DR7 and action rules AR1-AR5. Provided that no definition candidates are found, the process proceeds to the next segment (step 270). If at least one definition candidate is found in the segment, the method searches for nested definitions within this segment (step 230). After processing the segment, the method proceeds to process the next segment (step 290). The method ends when there are no more segments to process (step 240). An example for this process can be found in the rule DR6.

According to embodiments of the present invention the method distinguishes between segments of the text which contain definition(s) and segments which describe actions. The process of making these distinctions is comprised of three elements: syntax differences, the use of keywords and the format of the sentences. Finding syntax differences relies on two major factors. First, definitions tend to be in the present tense, as in “a token is a sequence of characters delimited by blanks or punctuation”; actions tend to be in future tense or in the imperative, as in “the system shall be accessible over the web”, or “remove the knob to access the engine”. Second, actions frequently use conditionals, as in “once accessed, the system shall display a welcome message” or “if more than one option is selected, a warning will be issued”.

The use of keywords relates to the fact that definitions often are expressed using keywords such as “define” or “describe”, as in “an index is defined as a sequence of three integers”, or “figure 2 depicts the organization of the system”. See rule DR1 for verb examples. Locating these keywords and their weights enables the identification of sentences which have a high probability of being definitions. A pronoun (a word that refers to a person or a thing that has already been talked about) can also be used to extend a definition candidate. See rule DR5. A noun phrase (NP) followed by a punctuation character like ‘;’ or ‘:’ can also used to identify definition candidate. See rule DR2. NP followed by a relativizer like ‘which’ or ‘that’ can also used to identify definition candidate. See rule DR3.

Additionally, the typographic format of documents frequently distinguishes between definitions and actions. Often in software requirement documents, a definitions paragraph is called “Definitions” and precedes an actions paragraph that is called “Requirements” and the definition titles are marked, such as by using boldface font. Analyzing the typographic format used in the documents and identifying the pattern of definitions formatting facilitates the process of identifying the definitions in the document.

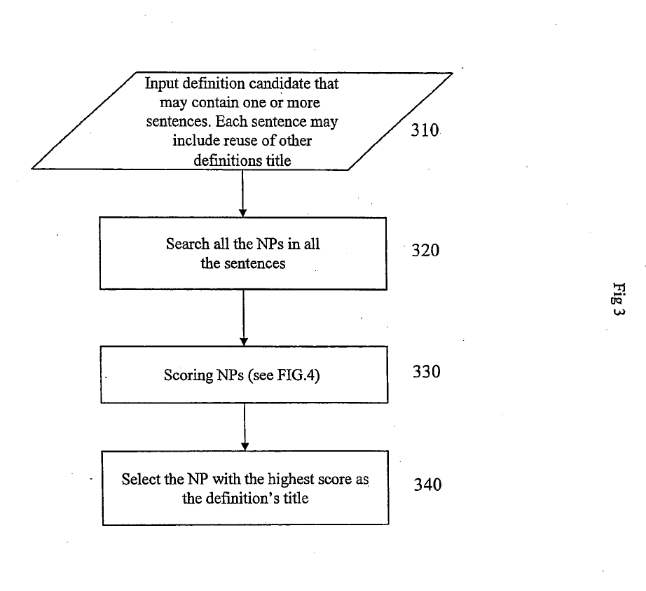

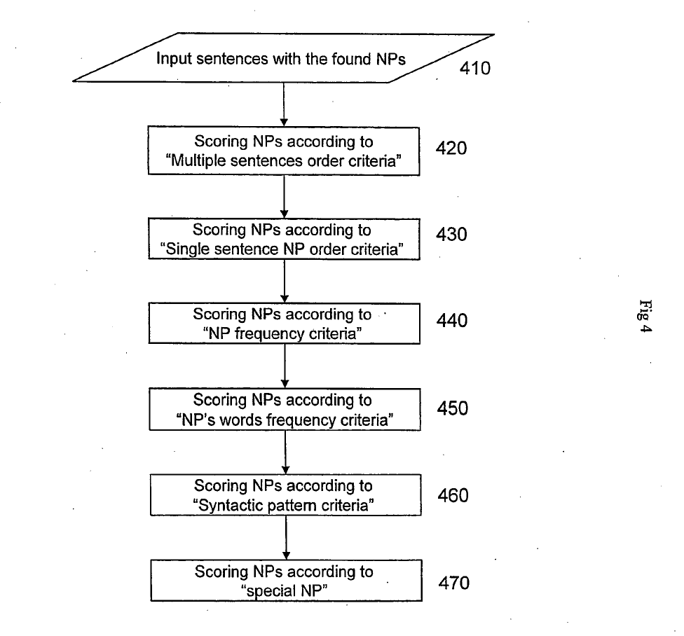

FIG. 3 presents a method for associating a title with a definition candidate in accordance with some embodiments of the present invention. The input definition description may contain one or more sentences. Each sentence may include already assigned definition titles (step 310). A definition title consists of a single noun phrase. See rule TR6. A search is made to find all the NPs that are candidates for a new definition title excluding already-used definition titles (step 320). A method for assigning scores to each NP 330 is further detailed in FIG. 4. The NP with the highest score is selected as the definition title for the input definition candidate (step 340).

FIG. 4 is an illustration of some of the criteria used in the process of assigning scores to the input NPs (step 410) in accordance with some embodiments of the present invention. Multiple sentences order (step 420) scores NPs according to sentence order. For instance, in some document styles, NPs in the first sentence are assigned higher scores. See rule TR5PL. Single sentence NP order (step 430) assigns scores to NPs according to the NP's location in the sentence. Rules TR5NH and TR5HW exemplify this step. For instance, in some phrasing styles, NPs at the beginning of the sentence are assigned higher scores. NP frequency (step 440) gives higher scores to NPs that are used multiple times in different sentences. See rule TR5FNP. NP word frequency (step 450) assigns higher scores to any NP whose content words are used more frequent in the document. See rule TR5FW as an example for this step. Syntactic pattern (step 460) assigns higher scores to NPs conforming to the weighted syntactic patterns verbs like rule DR1 which adhere to definition phrase patterns, such as “‘NP’ is a kind of . . . ”, “‘NP’ describes . . . ”, “‘NP’ is a method . . . ”. See rule TR5 for additional examples. The weight of each criterion is configurable, and can be different for any given project or document. Special NPs (step 470) assigns higher score to an acronym or name entity. See rules TR5AW, TR0 and TR5NE. If NP is already in use as a title in the definitions DB then it can not be used again for a new definition candidate. See rule TR5DB. Additional title rules can be applied for specific cases. See rules TR2, TR3 and TR4.

It is important to note that the order in which the score criteria are calculated is irrelevant since all criteria are independent of one another. Additionally, the criteria illustrated in FIG. 4 are used as example only, not all criteria need to be used and according to other embodiments of the present invention, other criteria may be used.

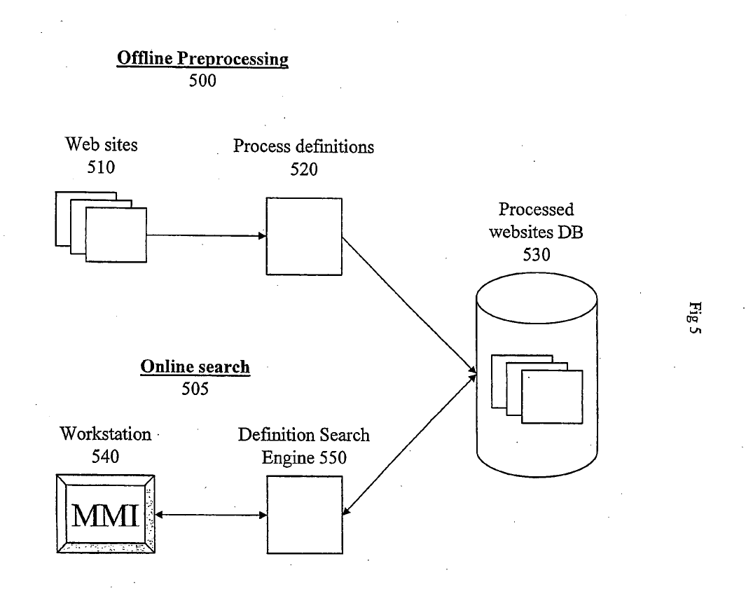

FIG. 5 is a block diagram illustrating the principle components of the search engine in accordance with embodiments of the present invention. The system is comprised of offline preprocessing components 500, online search components 505 and processed website database 530. The offline preprocessing components 500 are comprised of website interfaces 510 and process definitions 520. The definitions and the précis text are stored in database 530. The user can operate the system through workstation 540 which includes a dedicated Multi Media Interface (MMI) to allow the user to enter search keywords and to select the search method e.g. search only in the definition titles or search only in the definition description part. The definition search engine 550 executes the user request by appropriately searching in the DB 530 and sending back to the user 540 the search results e.g. definition(s) list(s) or parts of the précis text. See section marked as “Search engine example” in Appendix A for an example. According to some embodiments of the present invention, the system may be a web-based system, operating on a wide area network (WAN), or an intra-organizational system operating on a local area network (LAN). According to other embodiments the system may operate on a single workstation in stand-alone mode.

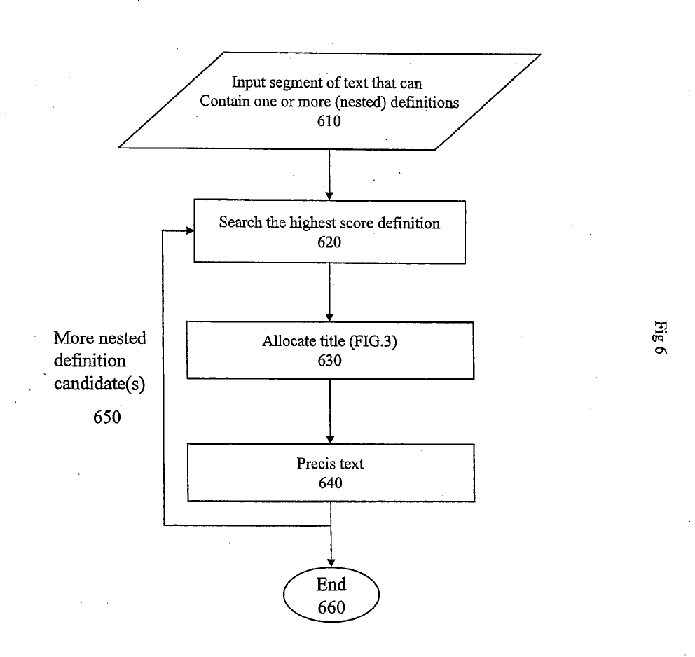

FIG. 6 is a flowchart illustrating the process of searching for nested definitions in accordance with embodiments of the present invention. For each input segment (step 610) the system searches for the highest scored definition candidate (step 620). Then the system associates a definition title with the definition (step 630). Next, the system generates the précis of the text by replacing the definition description with its title (step 640). This process continues until no more unprocessed nested definition(s) remain (step 650). The process is terminated after all definition candidates are processed (step 660). This process is exemplified in rule DR6.

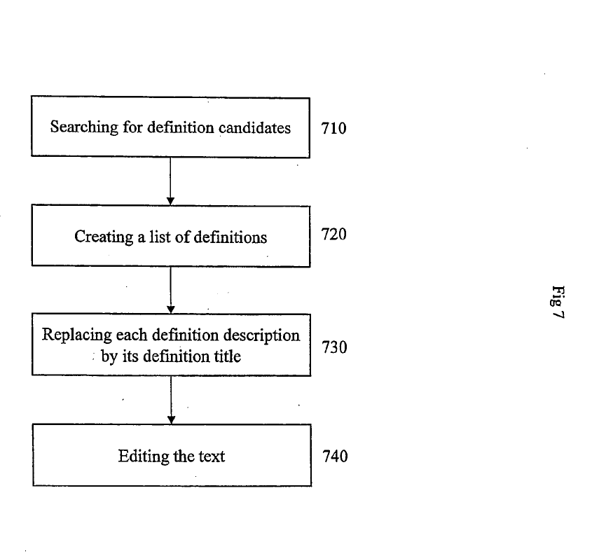

The précised text is a shorter presentation of the original text where each identified definition is replaced with its short definition title. FIG. 7 is a flowchart illustrating the process of producing the précis of a text in accordance with embodiments of the present invention. First, the system searches for definition candidates (step 710). Then the system creates a list of definitions, each consisting of a definition title and a definition description (step 720). See rule PR1. Next, the system replaces each definition description by its marked definition title (step 730). See rules PR2 and PR3. Finally, when substituting a definition title for a definition description, both the title and the surrounding text may undergo slight changes, e.g. in number, tense or voice, so that the resulting sentence is grammatically correct (step 740). See rules PR4 and PR5 for full examples.

The system and method described above can be used to improve the efficiency and effectiveness of existing internet search engines providing results of a better quality in less time. Currently, search engines index web pages by keywords; when given a query, they search the index for documents matching the query keywords. In addition, some engines display a snippet, which is a short part of the web page they return. The proposed technology can be used as a search engine in the following way: web pages are processed off-line to create a Definitions Search Engine (DSE) index, containing definitions, titles and précis text. Given a query, the DSE index is searched and the results are displayed. The user who utilizes the search engine can request that the query be searched in the original web index, the definition descriptions only, the definition titles only, the précis only, or in any combination thereof. The retrieved search results may be presented to the user with at least a partial list of definitions or partial précis of the results.

The following is a description of the efficiency and consistency calculations. It describes how the basic reuse quality is measured in two documents that are assumed to share the same definition library. A typical example of such a relation is when a parent document contains definition candidates which can be reused by a child document, thereby increasing the reuse quality. The parent document can also be a definition library. In other words, the reuse of definitions in a child document can be measured relative to existing definitions in a parent document or parent library. Reuse efficiency is defined according to the following formula:

#WDOC=number of words in the document;

#WDEF=number of words in all the definition candidates;

#WPRECIS=number of words in the précis text (excluding the definitions content in the definitions list)

Reuse efficiency =1−(#WDOC−#WDEF)/#WDOC

Given that:

#WPRECIS=(#WDOC−#WDEF)

we obtain:

Reuse efficiency =1−#WPRECIS/#WDOC

Several scenarios of definition reuse are possible, each affecting the reuse quality in a different way: full reuse, partial reuse and non-reuse (similar or none). Full reuse is when a definition in a parent document is fully reused if an equal definition is found in its child document. Full reuse increases the reuse efficiency and the reuse consistency. Partial reuse is when a definition description in one document is partially used in another document. In this case the reuse quality is determined by the user. The third non-reuse option is when a definition in the parent document is not found in the child document or when a similar definition is found. Two definitions are similar if their combined title and description parts are neither identical nor partially equal. The degree of similarity can be measured according to the edit distance between the two description parts measured in methods which are known to people who are skilled in the art. Additionally, weighted edit distance may be measured according to different parts of speech (POS) each scored differently. For example, equal NPs can be scored higher than equal verbs. Synonyms can also be used to calculate the edit distance. In some cases when using definition management tools such as Reusable Definitions System (RDS), as described in US Patent Application No. 20060184867, definitions can have more than one valid title or more then one valid description. These definitions are handled as identical and regarded as fully reused. If a definition in a parent document matches a similar definition in a child document, reuse efficiency and reuse consistency are decreased. Reuse efficiency and reuse consistency may be configurable to decrease when a definition in a parent document is not found at all in its child documents.

The following methods are used to automatically score the phrasing style by analyzing known definitions in existing documents or libraries. The methods are based on counting the number of times each rule is used, assigning higher scores to rules that are used more frequently. The scored definition candidates can be used in the nested algorithm, such that the definition with the highest score is selected first. Definition candidates with very low score, below a specified threshold, are ignored.

According to the scoring verbs method definition candidates search is done mainly according to verbs which are indicative of definitions such as “is a”, “define”, and “describes”. These verbs are grouped and are assigned scores, manually or automatically. See rule marked as DR1 for an example of assigning verb weights. The tense of the verb is also assigned a score. See rule DR4 for an example of assigning verb tense weights. Existing definition libraries can be used to score verbs by assigning higher scores to verbs that are used more frequently in the library. Scoring of verbs can be tailored to a specific organization, project or user by selecting a specific definition document(s) or library. Similarly, this concept can be used to associate scores with rules. See, for example, the section marked as TR and DR rules. According to this method, rules which appear more frequently are assigned higher scores.

In addition to the applications specified above, embodiments of the present invention may be accommodated to suite some other applications. For instance, the present invention may be used to automatically produce compilations of a definition index, similar to the table of contents or index of books. Additionally, it may be suited to produce on-line suggestion of definitions when integrated in a document text-editor, similar to on-line spell checking. Embodiments of the present invention may also be used to produce evaluations of documents according to the number and length of definition candidates relative to the document size. This evaluation may indicate how structured the document is since documents which have more or longer definition candidates are likely to be more structured.

Embodiments of the present invention may also be adopted to help individuals with learning disabilities. The précis and the list of definitions produced in accordance with the methods described above may aid people with learning disabilities to better understand documents they have to read since it presents the essential segments of the document content in short and exact format. Additionally, embodiments of the present invention may be integrated into tools which train people with learning disabilities to differentiate between the essential and the non-essential segments of the document.

The disclosed system and method may also be used as a particular type of pattern perception test. Using more and longer definition candidates may indicate more methodical thinking patterns and working habits. For this purpose a weight may be given to each examined parameter, such as the number and length of definition candidates. The total grade may be calculated experimentally and compared to other existing psychological pattern perception intelligence quotient (IQ) tests known in prior art.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

Below are examples of rules and methods as implemented by the embodiment in accordance with the present invention. Some predefined abbreviations and notations are used. Appendix A contains examples that show how the following rules are used to process text.

### Rule Abbreviations

DTC: Definition Title Candidate

DDC: Definition Description Candidate

Part of speech (POS) is a category of words based on their grammatical function. The abbreviations for part-of-speech tags are the same as used in the Penn Treebank.

http://www.ling.upenn.edu/courses/Fall_{—}2003/ling001/penn_treebank_pos.html

| Number | Tag | Description | Example |
|---|---|---|---|
| 0. | ACR | Acronym | UN, FN |
| 1. | CC | Coordinating conjunction | and, or, but |
| 2. | CD | Cardinal number | one, 3, sixth |
| 3. | DT | Determiner | the, this |
| 4. | EX | Existential there | there is, there |
| | | | are |
| 5. | FW | Foreign word | etc. |
| 6. | IN | Preposition or subordinating | of, before |
| | | conjunction | |
| 7. | JJ | Adjective | good, old |
| 8. | JJR | Adjective, comparative | better, older |
| 9. | JJS | Adjective, superlative | best, oldest |
| 10. | LS | List item marker | 1, 2, 3 . . . , |
| | | | a, b, c . . . |
| 11. | MD | Modal | will, should, |
| | | | would |
| 12. | NN | Noun, singular or mass | chair, aircraft |
| 13. | NNS | Noun, plural | chairs, pencils |
| 14. | NNP | Proper noun, singular | London, Mars |
| 15. | NNPS | Proper noun, plural | Contracts |
| 16. | PDT | Predeterminer | all |
| 17. | POS | Possessive ending | your, his |
| 18. | PRP | Personal pronoun | I, you, them |
| 19. | PRP$ | Possessive pronoun | ours, theirs |
| 20. | RB | Adverb | often, well |
| 21. | RBR | Adverb, comparative | Longer, better |
| 22. | RBS | Adverb, superlative | best, oldest |
| 23. | RP | Particle | not |
| 24. | SYM | Symbol | ,, ;, :, |
| 25. | TO | Infinitive marker | to |
| 26. | UH | Interjection | Yes, wow |
| 27. | VB | Verb, base form | be |
| 28. | VBD | Verb, past tense | was, were |
| 29. | VBG | Verb, gerund or present | being |
| | | participle | |
| 30. | VBN | Verb, past participle | been |
| 31. | VBP | Verb, non-3rd person | represent |
| | | singular present | |
| 32. | VBZ | Verb, 3rd person singular | represents |
| | | present | |
| 33. | WDT | Wh-determiner | which, that |
| 34. | WP | Wh-pronoun | who, whom |
| 35. | WP$ | Possessive wh-pronoun | theirs, ours |
| 36. | WRB | Wh-adverb | when, how, |
| | | | why |

### Common Rule Notations

< > = <definition candidate notation>

[ ] = [shallow parsing notation]

{ } = {rule notation}

{AR#} Action Rule e.g. {AR3}

{DR#} Definition Rule e.g. {DR1}

{TR#} Title Rule e.g. {TR2}

{PR#} Précis Rule e.g. {PR1}

Rules:

{DR1} rule: NP1_{DTC} followed by verb phrase (VP) that consists of one of the predefined verbs followed by NP2_{DDC}.

{DR1} example: “[Utopia]_{NP1} [is]_{VBZ} [an _{DT} imaginary concept that cannot exist in reality]_{NP2}”.

The following table depicts rules which assign weights (scores) to different {DR1} verbs. The weight column in the table is only an example that illustrates how different verbs are scored.

| DR1 sub | | |
|---|---|---|
| Rule | Verbs | Weight |
| V0 | “combines”, “includes” | x |
| V1 | “entail”, “is distinguished by”, ”comprise”, | x to xx |
| | ”delimit”, ”typify”, ”present”, ”depict”, | |
| | “predicate” | |
| V2 | “comprise”, “is based on”, “is by” | xx |
| V3 | “describes”, “represent”, , “connote”, “symbolize”, | xxx |
| | “stand for”, “specify”, “delineate”, “denote” | |
| V4 | “is [a, an, the]”, ”means”, “define”, “imply” | xxxx |
| V5 | “(is) defined (as)”, ”interpreted as”, “which is”, | xxxxx |
| | “that is” | |

{DR1}NOTE1: DDC may consist not only of the first NP appearing after the verb. It can consist of a conjunction of phrases that may include several NPs connected by conjunctions.

{DR1}NOTE2: Passive verbs such as “is used”, “is concerned” etc. do not indicate definitions. These verbs indicate a certain action describing a definition and it is possible to write a list of this kind of verbs.

{DR2} rule: NP1_{DTC} followed by punctuations, (except semicolon (‘;’)) tagged with SYM e.g. comma (‘,’), colon (‘:’), equal mark (‘=’), dash (‘-’) followed by NP2_{DDC} which starts with DT e.g. “a”, “the”.

{DR2} example: “[Islandia]_{NP1} [,]_{SYM} [an _{DT} imaginary island in the Southern hemisphere]_{NP2}.”

A special case of {DR2} is {DR2.1}

{DR2.1} rule: If NP1_{DTC} is: “table”, “diagram”, or “figure” then NP1_{DTC1} and NP2_{DTC2} are both title candidates which refers to the description part e.g. NP3_{DDC} (the table itself).

{DR2.1} example:

[table]_{NP1}[:]_{SYM} [system process1]_{NP2}
NP3 (the table bellow):

| A | B |
|---|---|
| Islandia | an imaginary island in the |
| | Southern hemisphere |

{DR2.1}NOTE: Even though NP2 is first classified as a description, it becomes a title since the table itself becomes the description.

{DR3} rule: NP1_{DTC} followed by a relativizer e.g. “which”, “that”, followed by V that consists of one of the predefined verbs (shown in {DR1}) followed by NP2_{DDC}.

{DR3} example: “[Consistency]_{NP1} [that_{WDT}]_{NP} [means]_{VP} [the property of . . . ]_{NP2}”

{DR4} rule: The scoring of the verbs (shown in {DR1}) that appear in a definition is done according to their tenses, see table below:

| Rule | Description | Weight |
|---|---|---|
| T1 | simple present e.g. “imply”, “represent” | xxxxx |
| | present continuous e.g. “is implying” | |
| | simple past e.g. “defined” | |
| T2 | simple future e.g. “will represent” | xxx |
| | future continuous e.g. “will be representing“, | |
| | “going to be representing” | |
| T3 | past continuous e.g. ”was representing” | xx |
| | past perfect e.g. “had described” | |
| T4 | past perfect continuous e.g. “had been representing” | x |

(DR5} rule: A pronoun mentioned in the sentence (i) refers to a definition title that is defined in sentence (i-1). The sentence which includes the anaphoric pronoun then becomes a part of the definition.

{DR5} example: “<Sequence> is defined as serial arrangement in which things follow in logical order. ‘It’ can also pursue a recurrent pattern”.

{DR6} rule: Paragraphs containing at least one definition candidate are searched according to the nested definition search steps:

Step 1. Do POS tagging.

Step 2. Find acronyms. If found:
Step 2a replace each acronym definition with the acronym.
Step 2b tag the acronym with/ACR

Step 3. Using POS tags, do shallow parsing.

Step 4. Find all definitions and actions in the paragraph.

Step 5. Select the definition with the highest scored.

Step 6. Generate précis text according to the selected definition.
NOTE in this step a shorter text is produced to simplify the following process—long and complex paragraphs can be reduced to shorter and less complex paragraphs for further text analysis.

Step 7. Continue steps 4-6 until no more definitions are found.

{DR7} rule: The paragraph boundaries are determined according to the following table:

| Rule | Description | Weight |
|---|---|---|
| P1 | A paragraph starts with a new empty line. | xxxx |
| P2 | A paragraph starts with a new line. | xxx |
| P3 | A table, diagram, figure etc. starts a new paragraph. | xxxxx |
| P4 | P1, P2 or P3 and instances in which the first word in | xxxxx |
| | the paragraph starts with an indentation. | |

{DR7}NOTE: Weights are configurable (can be tailored for different applications).

{AR1} rule: NP1 followed by a relative clause that consists of WDT (e.g. “that”), followed by a VP that consists of MD and VB and VBN followed by NP2.

{AR1} example: “We introduce [the reference configuration]_{NP1} [that]_{WDT} [will]_{MD} [be]_{VB} [used]_{VBN} [throughout the present document.]_{NP2}”

{AR2} rule: NP1 followed by VP that consists of MD and VB and VBN followed by NP or PP.

{AR2} example: “[The term manipulation]_{NP1} [could]_{MD} [be]_{VB} [used]_{VBN} [to predict an action]_{PP}”

{AR3} rule: NP1 followed by VP that consists of MD and VB followed by NP or PP

{AR3}example: “[Reflections]_{NP1} [should]_{MD} [refer]_{VB} [to the relation between

phenomena and their essence]_{NP}”.

{AR4} rule: NP1 followed by VBZ that is not in the predefined verbs (e.g. “requires”, “depicts”) followed by NP2.

{AR4} example: “[The city of sun]_{NP1} [depicts]_{VBZ} [a theocratic and communist society]_{NP2}”

{AR5} rule: NP1 appears after IN (such as “if”) that indicates conditional NP followed by one of the predefined verbs e.g. VP that consists of VBZ and VBN followed by NP2.

{AR5}example: “If [methodname]_{NP1} [is]_{VBZ} [defined]_{VBN} [as a macro at the current point in the program, a warning will be issued]_{NP2}”

{PR1} rule: If a definition candidate is found it is added to the list of definitions.

{PR2} rule: Definition title is marked e.g. with double line.

{PR3} rule: If a definition candidate is found, its description part is replaced with its title.
NOTE: If the title of a definition candidate is not used in the document, the definition is not removed from the précis text due to information lost.

{PR4} rule: If the title does not appear as the subject then the sentence is changed so that the title becomes the subject e.g. object becomes a subject

{PR4}example:
A record for each message is [a <message index>]_{object}.
[A <message index>]_{subject} is a record for each message.

{PR5} rule: If the title is not grammatically correct e.g. due to singular and plural mixture, the title is changed.

{PR5}example:
the title in the sentence “ . . . number of <logical channel>” is corrected to “ . . . number of <logical channels>.

{TR0} rule: If a word tagged with NNP appears within parenthesis and consists of only capital letters e.g. European Union ([EU]_{NNP}) then the NNP is an acronym provided that the acronym of the specific words is found in the text or in a acronym library.

{TR1} rule: if DDC is longer than DTC, then DDC and DTC are replaced.

{TR1}example:

“[An often used measure in the information retrieval and natural language processing communities]_{DTC} is the [F-measure]_{DDC}”

DTC>DDC and is therefore processed as follows:

“[An often used measure in the information retrieval and natural language processing communities]_{DDC} is the [F-measure]_{DTC}”

{TR2} rule: If two titles are found separated with “or”

Example: “sentence or expression”, choose the title that has the highest score.

{TR3} rule: If two titles include the same definition then the more detailed title will get a higher score.

{TR3} example: “<license>(<insurance license>)”, DTC is: <insurance license>.

{TR3} NOTE: the score of this rule is in addition to other title rules scores.

{TR4} rule: if a title DTC starts with DT (pronoun, determiner) e.g. “the”, “a”, it is ignored in the title name.

{TR4} example: “[the term]_{NP}”, “[<term>]_{DTC}”.

{TR5} rule: A title is scored based on the following table:

| | Rule | Description | Weight |
|---|---|---|---|
| 1 | FW | Words in the title that are used frequently | x to |
| | | in the document. | xxx |
| | | The score is higher for higher frequency. | |
| 2 | FNP | The frequency of the title in the document. | xxx |
| 3 | AW | An acronym title. | xxxx |
| 4 | NE | Name entity title. | xxxx |
| 5 | DB | The title is already in used and found in | xxxxx |
| | | the definition database. | |
| | | Note: same title can not be allocated to | |
| | | different description parts. | |
| 6 | HW | The title is tagged with NNP and is the first | xx |
| | | word in the sentence. | |
| 7 | NH | The title is not head title (does not appear | x |
| | | at the beginning of the sentence, NN). | |
| 8 | PL | Titles in a paragraph are scored according | xxxxx |
| | | to sentence order, e.g., a title in the first | to x |
| | | sentence is scored with xxxxx (gets the highest | |
| | | score), second sentence xx, third x. | |
| | | Note: Sometimes a title that does not appear | |
| | | in the first sentence gets a higher score | |
| | | because of the sum of other scoring rules. | |

{TR5}NOTE: more than one rule can be used to score a title. Some rules are overlapped and the score should be added only once e.g. the case where a title is an acronym and also a named entity.

{TR6} rule: A title consists of only one NP.

{TR6}NOTE: NP can consist of more than one noun (NN) according to the shallow parser.

{TR7} rule: score NP according to its associated syntactic pattern verb and the verb keywords (as in rule DR1).

<Online ordering> should handle the most basic products and services, while more complex orders are taken.

1.3. List of Definitions

<advanced link>
advanced link is a bi-directional connection oriented path between one MS and a BS with provision of acknowledged and unacknowledged services, windowing, segmentation, extended error protection and choice among several throughputs.
<logical channel>
logical channel represents the interface between the protocol and the radio.
<message index>
message index is a record for each message that will be used to point to the SDS message in the stack.
<Online ordering>
online ordering denotes the introduction of a new service to all our customers in the small volume segment.
<physical channels>
physical channels are defined:

the TP carrying mainly traffic channels; and

the CP carrying exclusively the control channel.

TABLE 1

| | Length | Length | | | |
|---|---|---|---|---|---|
| Information element | 2 | 8 | Type | C/O/M | Remark |
| PDU Type | | | 1 | M | |
| SDS type | 3 | 1 | 1 | M | |
| Number of messages | 8 | 1 | 1 | M | |
| <Message index> | 16 | 1 | | C | note 1, |
| | | | | | note 2 |

NOTE 1:
Shall be repeated as defined by the number of messages to be deleted.
NOTE 2:
The <message index> is a record for each message that will be used to point to the SDS message in the stack.
<TEMTA-SDS DELETE MESSAGES REQ PDU> == <Table1>

1.4. Segments

1.4.1. First Segment

The radio subsystem provides a certain number of logical channels. The logical channel represents the interface between the protocol and the radio.

1.4.1.1. Step 1—Part-of-Speech Tagging

Included in step 3 shallow parsing

1.4.1.2. Step 2—Acronym Search

### None

✓

### APPENDIX 1

### Examples

<definition notation>

### 1. Example

### 1.1. Original Text

zone MS and a BS with provision of acknowledged and unacknowledged services, windowing, segmentation, extended error protection and choice among several throughputs.
An advanced link requires a set-up phase.
Before using an advanced link the user will be asked to answer a few questions that are essential for the set-up phase requirements.
The PDU shall be used to delete from an MT2 a list of SDS messages in the SDS message stack as defined in table 1.

TABLE 1
TEMTA-SDS DELETE MESSAGES REQ PDU

| | Length | Length | | | |
|---|---|---|---|---|---|
| Information element | 2 | 8 | Type | C/O/M | Remark |
| PDU Type | | | 1 | M | |
| SDS type | 3 | 1 | 1 | M | |
| Number of messages | 8 | 1 | 1 | M | |
| Message index | 16 | 1 | | C | note 1, |
| | | | | | note 2 |

NOTE 1:
Shall be repeated as defined by the number of messages to be deleted.
NOTE 2:
The message index is a record for each message that will be used to point to the SDS message in the stack.

Two types of physical channels are defined:

the Traffic Physical channel (TP) carrying mainly traffic channels; and

the Control Physical channel (CP) carrying exclusively the control channel.

The online ordering denotes the introduction of a new service to all our customers in the small volume segment. Online ordering should handle the most basic products and services, while more complex orders are taken.

### 1.2. Précis Text

The radio subsystem provides a certain number of <logical channels>.
An <advanced link> requires a set-up phase.
Before using an <advanced link> the user will be asked to answer a few questions that are essential for the set-up phase requirements.
The PDU shall be used to delete from an MT2 a list of SDS messages in the SDS message stack as defined in <TEMTA-SDS DELETE MESSAGES REQ PDU>.
Two types of physical channels are defined:

the TP carrying mainly traffic channels; and

the CP carrying exclusively the control channel.

1.4.1.3. Step 3—Shallow Parsing

[NP The/DT radio/NN subsystem//NN NP] [VP provides/VBZ VP] [NP a/DT certain/JJ number/NN NP] {PNP [Prep of/IN Prep] [NP logical/JJ channels/NNS NP] PNP} ./. [NP The/DT logical/JJ channel/NNS NP] [VP represents/VBP VP] [NP the/DT interface//NN NP] {PNP [Prep between/IN Prep] [NP the/DT protocol//NN NP] and/CC [NP the/DT radio/NN NP] PNP} ./.

1.4.1.4. Step 4—Definition Rules

Definition found:
1) logical channel represents the interface . . . {DR1V3}
No Action found.

1.4.1.5. STEP 5-Select Highest Scored DEF

Definition title:
<logical channel> {TR5HW}
Definition description:
<logical channel> represents the interface between the protocol and the radio. . . . {DR4T1}

1.4.1.6. Step 6—Précis Text

The radio subsystem provides a certain number of <logical channels>. {PR2}{PR3}{PR5}

1.4.2. Second Segment

An advanced link is a bi-directional connection oriented path between one MS and a BS with provision of acknowledged and unacknowledged services, windowing, segmentation, extended error protection and choice among several throughputs.
An advanced link requires a set-up phase.

1.4.2.1. Step 1—Part-of-Speech Tagging

Included in step 3 shallow parsing

1.4.2.2. Step 2—Acronym Search

### None

1.4.2.3. Step 3 Shallow Parsing

[NP An/DT advanced/JJ link/NN NP] [VP is/VBZ VP] [NP a/DT bi-directional//JJ connection/NN oriented/JJ path/NN NP] {PNP [Prep between/IN Prep] [NP one/CD MS//NNP NP] and/CC [NP a/DT BS//NNS NP] PNP} {PNP [Prep with/IN Prep] [NP provision/NN NP] PNP} {PNP [Prep of/IN Prep] [NP acknowledged/VBN and/CC NP] [ADJP unacknowledged//JJ ADJP] [NP services/NNS NP] PNP} ,/, [VP windowing//VBG VP] ,/, [NP segmentation//NN NP] ,/, [NP extended/JJ error/NN protection/NN NP] and/CC [NP choice/NN NP] {PNP [Prep among/IN Prep] [NP several/JJ throughputs//NNS NP] PNP} ./.
[NP An/DT advanced/JJ link/NN NP] [VP requires/VBZ VP] [NP a/DT set-up//NN phase/NN NP] ./.

1.4.2.4. Step 4 Definition Rules

Definition found:
An advanced link is a bi-directional . . . {DR1V4}
Action found:
1) An advanced link requires a set-up phase. {AR4}

1.4.2.5. Step 5—Select Highest Scored DEF

Definition title:
An <advanced link> {TR5HW}
Definition description:
An <advanced link> is a bi-directional connection oriented path between one MS and a BS with provision of acknowledged and unacknowledged services, windowing, segmentation, extended error protection and choice among several throughputs.

1.4.2.6. Step 6—Précis Text

An <advanced link> requires a set-up phase.
Before using an <advanced link> the user will be asked to answer a few questions that are essential for the set-up phase requirements. {PR2}{PR3}

1.4.3. Third Segment

Before using an advanced link the user will be asked to answer a few questions that are essential for the set-up phase requirements.

1.4.3.1. Step 1—Part-Of-Speech Tagging

Included in step 3 shallow parsing

1.4.3.2. Step 2—Acronym Search

### None

1.4.3.3. Step 3—Shallow Parsing

[Prep Before/IN Prep] [VP using/VBG VP] [NP an/DT advanced/JJ link/NN NP] [NP the/DT NP] [NP user/NN NP] [VP will/MD be/VB asked/VBN to/TO answer/VB VP] [NP a/DT few/JJ questions/NNS NP] [NP that/WDT NP] [VP are/VBP VP] [ADJP essential/JJ ADJP] {PNP [Prep for/IN Prep] [NP the/DT set-up//NN phase/NN requirements/NNS NP] PNP} ./.

1.4.3.4. Step 4—Definition Rules

No definitions found!
Action found:
1) user will be asked to answer . . . {AR2}

1.4.4. Fourth Segment

The PDU shall be used to delete from an MT2 a list of SDS messages in the SDS message stack as defined in table 1.

1.4.4.1. Step 1—Part-Of-Speech Tagging

Included in step 3 shallow parsing

1.4.4.2. Step 2—Acronym Search

### None

1.4.4.3. Step 3—Shallow Parsing

[NP The/DT PDU//NNP NP] [VP shall/MD be/VB used/VBN to/TO delete//VB VP] {PNP [Prep from/IN Prep] [NP an/DT MT2//CD NP] PNP} [NP a/DT NP] [NP list/NN NP] {PNP [Prep of/IN Prep] [NP SDS//NNPS messages/NNS NP] PNP} {PNP [Prep in/IN Prep] [NP the/DT SDS//NNPS message/NN stack/NN NP] PNP} [C as/IN C] [VP defined/VBN VP] {PNP [Prep in/IN Prep] [NP table/NN 1/CD NP] PNP} ./.

1.4.4.4. Step 4—Definition Rules

Definition found:

### 1) Table 1: TEMTA-SDS DELETE MESSAGES REQ PDU {DR2.1}

Action found:
1) The PDU shall be used to delete . . . {AR2}

1.4.4.5. Step 5—Select Highest Scored DEF

Definition titles:
<table 1>

### <TEMTA-SDS DELETE MESSAGES REQ PDU>

Definition description:
<table 1>: TEMTA-SDS DELETE MESSAGES REQ PDU
NOTE: Even though TEMTA-SDS DELETE MESSAGES REQ PDU is first classified as a description, it becomes a title since the table itself becomes the description.

1.4.4.6. Step 6—Précis Text

The PDU shall be used to delete from an MT2 a list of SDS messages in the SDS message stack as defined in <TEMTA-SDS DELETE MESSAGES REQ PDU> {PR2}{PR3}

1.4.5. Fifth Segment

NOTE 1: Shall be repeated as defined by the number of messages to be deleted.
NOTE 2: The message index is a record for each message that will be used to point to the SDS message in the stack.

1.4.5.1. Step 1—Part-Of-Speech Tagging

Included in step 3 shallow parsing

1.4.5.2. Step 2—Acronym Search

### None

1.4.5.3. Step 3 Shallow Parsing

[NP NOTE//NN 1:%09Shall//JJ NP] [VP be/VB repeated/VBN VP] [C as/IN C] [VP defined/VBN VP] {PNP [Prep by/IN Prep] [NP the/DT number/NN NP] PNP} {PNP [Prep of/IN Prep] [NP messages/NNS NP] PNP} [VP to/TO be/VB deleted//VBN VP] ./.
[NP NOTE//NN 2:%09The//JJ message/NN index/NN NP] [VP is/VBZ VP] [NP a/DT record/NN NP] {PNP [Prep for/IN Prep] [NP each/DT message/NN NP] PNP} [NP that/WDT NP] [VP will/MD be/VB used/VBN VP] {PNP [Prep to/TO Prep] [NP point/NN NP] PNP} {PNP [Prep to/TO Prep] [NP the/DT SDS//NNPS message/NN NP] PNP} {PNP [Prep in/IN Prep] [NP the/DT stack/NN NP] PNP} ./.

1.4.5.4. Step 4—Definition Rules

Definition found:
1) The message index is a record . . . {DR1V4}
Action found:
1) Shall be repeated as defined by the number . . . {AR2}
2) message that will be used to point . . . {AR1}

1.4.5.5. Step 5—Select Highest Scored DEF

Definition title:
The <message index>
Definition description:
The <message index> is a record for each message that will be used to point to the SDS message in the stack.

1.4.5.6. Step 6—Précis Text

The message index is a record for each message that will be used to point to the SDS message in the stack. {PR1}

1.4.6. Sixth Segment

Two types of physical channels are defined:

the Traffic Physical channel (TP) carrying mainly traffic channels; and

the Control Physical channel (CP) carrying exclusively the control channel;

1.4.6.1. Step 1—Part-Of-Speech Tagging

Included in step 3 shallow parsing

1.4.6.2. Step 2—Acronym Search

Step 2a Traffic Physical channel (TP) {TR0}
Control Physical channel (CP) {TR0}

### Step 2b TP/ACR CP/ACR

1.4.6.3. Step 3 Shallow Parsing

[NP Two/CD types/NNS NP] {PNP [Prep of/IN Prep] [NP physical/JJ channels/NNS NP] PNP} [VP are/VBP defined/VBN VP] :/: -/: [NP the/DT Traffic/NNP Physical//NNP channel/NN NP] (/( [NP TP//NNP NP] )/) [VP carrying/VBG mainly/RB traffic/VB VP] [NP channels/NNS NP] ;/: and/CC -/: [NP the/DT Control/NNP Physical//NNP channel/NN NP] (/( [NP CP//NNP NP] )/) [VP carrying/VBG VP] [ADVP exclusively/RB ADVP] [NP the/DT control/NN channel/NN NP] ./.

1.4.6.4. Step 4—Definition Rules

Definition found:
1) Two types of physical channels are defined: . . . {DR1V5}
No Action found!

1.4.6.5. Step 5—Select Highest Scored DEF

Definition title:
Two types of <physical channels>
Definition description:
Two types of <physical channels> are defined:

the TP carrying mainly traffic channels; and

the CP carrying exclusively the control channel.

NOTE: the title <physical channels> is chosen rather than <two types of physical channels> since according to the {DR} rules the first NP appearing before the verb is the title chosen.

1.4.6.6. Step 6—Précis Text

Two types of physical channels are defined:

the TP carrying mainly traffic channels; and

the CP carrying exclusively the control channel.

1.4.7. Seventh Segment

The online ordering denotes the introduction of a new service to all our customers in the small volume segment. Online ordering should handle the most basic products and services, while more complex orders are taken.

1.4.7.1. Step 1—Part-Of-Speech Tagging

Included in step 3 shallow parsing

1.4.7.2. Step 2—Acronym Search

### None

1.4.7.3. Step 3 Shallow Parsing

[NP The/DT online//CD ordering/NN NP] [VP denotes//VBZ VP] [NP the/DT introduction/NN NP] {PNP [Prep of/IN Prep] [NP a/DT new/JJ service/NN NP] PNP} {PNP [Prep to/TO Prep] [NP all/PDT our/PRP$ customers//NNS NP] PNP} {PNP [Prep in/IN Prep] [NP the/DT small/JJ volume/NN segment/NN NP] PNP} ./. [NP Online//CD ordering/NN NP] [VP should/MD handle/VB VP] [NP the/DT most/RBS basic/JJ products/NNS and/CC services/NNS NP] ,/, [C while/IN C] [NP more/JJR complex/JJ orders/NNS NP] [VP are/VBP taken/VBN VP] ./.

1.4.7.4. Step 4—Definition Rules

Definition found:
1) The online ordering denotes the introduction . . . {DR1V3}
Action found:
1) Online ordering should handle the most basic . . . {AR3}

1.4.7.5. Step 5—Select Highest Scored DEF

Definition title:
The <online ordering>
Definition description:
The <online ordering> denotes the introduction of a new service to all our customers in the small volume segment. {DR4T1}

1.4.7.6. Step 6—Précis Text

<Online ordering> should handle the most basic products and services, while more complex orders are taken. {PR2}{PR3}

### 2. Example

### 2.1. Original Text

Electronic text is essentially just a sequence of characters.
An often used measure in the information retrieval and natural language processing communities is the F-measure. According to Yang Yiming, this measure combines recall (r) and precision (p) with an equal weight in the following form:

F1(r;p)=2rp/(r+p)

A weighted version of the F-measure is by computing a weighted average of the inverses of the values, i.e.:

Fβ=(β+1)rp/(r+βp)

Sequence is defined as serial arrangement in which things follow in logical order or a recurrent pattern.

### 2.2. Précis Text

Electronic text is essentially just a <sequence> of characters.
An often used measure in the information retrieval and natural language processing communities is the <F-measure>.
A weighted version of the <F-measure> is by computing a weighted average of the inverses of the values i.e. <Fβ>.

### 2.3. List Of Definitions

<weighted version of the F-measure>
weighted version of the <F-measure> is by computing a weighted average of the inverses of the values <Fβ>.

### <F-measure>

An often used measure in the information retrieval and natural language processing communities is the F-measure.
According to Yang Yiming, this measure combines recall (r) and precision (p) with an equal weight in the following form: <F1(r;p)>.

<F1(r;p)>

F1(r;p)=2rp/(r+p)

<Fβ>

Fβ=(β+1)rp/(r+βp)

### <Sequence>

Sequence is defined as serial arrangement in which things follow in logical order or a recurrent pattern.
NOTE: A definition may be found after its reuse location e.g. <Sequence> that was found in the 4th segment is reused in the first segment as seen in the précis text result.

### 2.4. Segments

2.4.1. First Segment

Electronic text is essentially just a sequence of characters.

2.4.1.1. Step 1—Part-of-Speech Tagging

Included in step 3 shallow parsing

2.4.1.2. Step 2—Acronym Search

### None

2.4.1.3. Step 3 Shallow Parsing

[NP Electronic/JJ text/NN NP] [VP is/VBZ VP] [ADVP essentially/RB just/RB ADVP] [NP a/DT sequence/NN NP] {PNP [Prep of/IN Prep] [NP characters/NNS NP] PNP} ./.

2.4.1.4. Step 4—Definition Rules

No definitions found!
No Actions found!

2.4.2. Second Segment

An often used measure in the information retrieval and natural language processing communities is the F-measure. According to Yang Yiming, this measure combines recall . (r) and precision (p) with an equal weight in the following form:

F1(r;p)=2rp/(r+p)

2.4.2.1. Step 1—Part-Of-Speech Tagging

Included in step 3 shallow parsing.

2.4.2.2. Step 2—Acronym Search

### None

2.4.2.3. Step 3 Shallow Parsing

[NP An/DT NP] [VP often/RB used/VBD VP] [NP measure/NN NP] {PNP [Prep in/IN Prep] [NP the/DT information/NN retrieval//NN NP] and/CC [NP natural/JJ language/NN processing/NN communities/NNS NP] PNP} [VP is/VBZ VP] [NP the/DT F-measure//NNP NP] ./. [Prep According/VBG Prep] {PNP [Prep to/TO Prep] [NP Yang/NNP Yiming//NNP NP] PNP} ,/, [NP this/DT measure/NN NP] [VP combines/VBZ recall/VB VP] (/( [NP r//NN NP] )/) and/CC [NP precision/NN NP] (/( [NP p/NN NP] )/) {PNP [Prep with/IN Prep] [NP an/DT equal/JJ weight/NN NP] PNP} {PNP [Prep in/IN Prep] [NP the/DT following/JJ form/NN NP] PNP} :/: [NP F1(r//CD NP] ;/: [NP p/NN NP] )/) [VP =//SYM VP] [NP 2rp//JJ NP] //SYM (/( [NP r//NN NP] +/SYM [NP p/NN NP] )/)

2.4.2.4. Step 4—Definition Rules (LOOP1)

Definition found:
1) An often used measure in the information retrieval and natural language processing communities is the . . . {DR1V4}
2) F1(r;p)=2rp/(r+p) {DR2}
No Action found!

2.4.2.5. Step 5—Select Highest Scored DEF

Definition title:

<F1(r;p)>

Definition description:

<F1(r;p)>=2rp/(r+p)

2.4.2.6. Step 6—Précis Text (Interim)

<F1(r;p)> {PR2}{PR3}

2.4.2.7. Step 4—Definition Rules (LOOP2)

Definition found:
1) An often used measure in the information retrieval and natural language processing communities is the . . . {DR1V4}
No Action found!

2.4.2.8. Step 5—Select Highest Scored DEF

Definition title:

### the <F-measure>. {TR1}{TR5PL}

Definition description: An often used measure in the information retrieval and natural language processing communities is the <F-measure>. According to Yang Yiming, this measure combines recall (r) and precision (p) with an equal weight in the following form: <F1(r;p)>. {DR5}

2.4.2.9. Step 6—Précis Text (Final)

An often used measure in the information retrieval and natural language processing communities is the <F-measure>. {PR2}{PR3}

2.4.3. Third Segment

A weighted version of the F-measure is by computing a weighted average of the inverses of the values, i.e.:

Fβ=(β+1)rp/(r+βp)

2.4.3.1. Step 1—Part-Of-Speech Tagging

Included in step 3 shallow parsing

2.4.3.2. Step 2—Acronym Search

### None

2.4.3.3. Step 3 Shallow Parsing

[NP A/DT weighted/JJ version/NN NP] {PNP [Prep of/IN Prep] [NP the/DT F-measure//NNP NP] PNP} [VP is/VBZ VP] {PNP [Prep by/IN Prep] [NP computing/NN NP] PNP} [NP a/DT NP] [NP weighted/JJ average/NN NP] {PNP [Prep of/IN Prep] [NP the/DT inverses//NNS NP] PNP} {PNP [Prep of/IN Prep] [NP the/DT values/NNS NP] PNP} ,/, [ADVP i.e./NN ADVP] :/:
[NP F%DF//NN NP] [VP =//SYM VP] (/( [NP %/NN DF/NN NP]+/SYM [NP 1)rp//JJ NP] //SYM (/( [NP r//NN NP]+/SYM [NP %/NN DFp//NNP NP] )/)

2.4.3.4. Step 4—Definition Rules (LOOP1)

Definition found:
A weighted version of the <F-measure> is by . . . {DR1V2}

Fβ=(β+1)rp/(r+βp){DR2}

No Action found!

2.4.3.5. Step 5—Select Highest Scored DEF

Definition title:

### <Fβ>

Definition description:

<Fβ>=(β+1)rp/(r+βp)

2.4.3.6. Step 6—Précis Text (Interim)

### <Fβ> {PR2}{PR3}

2.4.3.7. Step 4—Definition Rules (LOOP2)

Definition found:
1) A weighted version of the <F-measure> is by . . . {DR1V2}
No Action found!

2.4.3.8. Step 5—Select Highest Scored DEF

Definition title:
A <weighted version of the F-measure>
Definition description:
A <weighted version of the F-measure> is by computing a weighted average of the inverses of the values, i.e.: Fβ

2.4.3.9. Step 6—Précis Text (Final)

A weighted version of the <F-measure> is by computing a weighted average of the inverses of the values i.e. <Fβ>. [PR2}

2.4.4. Fourth Segment

Sequence is defined as serial arrangement in which things follow in logical order or a recurrent pattern.

2.4.4.1. Step 1—Part-Of-Speech Tagging

Included in step 3 shallow parsing

2.4.4.2. Step 2—Acronym Search

### None

2.4.4.3. Step 3 Shallow Parsing

[NP Sequence//NNP NP] [VP is/VBZ defined/VBN VP] {PNP [Prep as/IN Prep] [NP serial/JJ arrangement/NN NP] PNP} [Prep in/IN Prep] [NP which/WDT NP] [NP things/NNS NP] [VP follow/VBP VP] {PNP [Prep in/IN Prep] [NP logical/JJ order/NN NP] or/CC [NP a/DT recurrent//JJ pattern/NN NP] PNP} ./.

2.4.4.4. Step 4—Definition Rules

Definition found:
1) Sequence is defined as serial . . . {DR1V5}
No Action found!

2.4.4.5. Step 5—Select Highest Scored DEF

Definition title:

### <Sequence> {TR5HW}

Definition description:
<Sequence> is defined as serial arrangement in which things follow in logical order or a recurrent pattern. {DR4T1}

2.4.4.6. Step 6—Précis Text

Electronic text is essentially just a <sequence> of characters. {PR2}{PR3}

### 3. Example

This example illustrates the appearance of definition verbs in different tenses.

### 3.1. Original Text

The Elements of UML 2.0 Style describe a collection of standards, conventions, and guidelines for creating effective UML diagrams which are based on proven software engineering principles, easier to understand and work with. These conventions exist as a collection of simple, concise guidelines which will represent an important first step in increasing your productivity as a modeller.

### 3.2. Précis Text

The Elements of UML 2.0 Style describe a collection of standards, conventions, and guidelines for creating effective <UML diagrams>. These conventions exist as a collection of simple, <concise guidelines>.

### 3.3. List Of Definitions

<concise guidelines>
concise guidelines which will represent an important first step in increasing your productivity as a modeller.

### <Elements of UML 2.0 Style>

Elements of UML 2.0 Style describe a collection of standards, conventions, and guidelines for creating effective <UML diagrams>. These conventions exist as a collection of simple, <concise guidelines>.
<UML diagrams>
UML diagrams which are based on proven software engineering principles, easier to understand and work with.

### 3.4. Segments

3.4.1. First Segment

The Elements of UML 2.0 Style describe a collection of standards, conventions, and guidelines for creating effective UML diagrams which are based on proven software engineering principles, easier to understand and work with. These conventions exist as a collection of simple, concise guidelines which will represent an important first step in increasing your productivity as a modeller.

3.4.1.1. Step 1—Part-Of-Speech Tagging

Included in step 3 shallow parsing

3.4.1.2. Step 2—Acronym Search

### None

3.4.1.3. Step 3 Shallow Parsing

[NP The/DT Elements//NNS NP] {PNP [Prep of/IN Prep] [NP UML//NNP NP] PNP} 2.0//CD [NP Style//NNP NP] [VP describes/VBZ VP] [NP a/DT collection/NN NP] {PNP [Prep of/IN Prep] [NP standards/NNS NP] PNP} ,/. [NP conventions/NNS NP] ,/, and/CC [NP guidelines/NNS NP] [Prep for/IN Prep] [VP creating/VBG VP] [NP effective/JJ UML//NNP diagrams/NNS NP] [NP which/WDT NP] [VP are/VBP based/VBN VP] {PNP [Prep on/IN Prep] [NP proven/JJ software/NN engineering/NN principles/NNS NP] PNP} ,/, [ADJP easier/JJR ADJP] [VP to/TO understand/VB and/CC work/VB VP] [Prep with/IN Prep] ./. [NP These/DT conventions/NNS NP] [VP exist/VBP VP] {PNP [Prep as/IN Prep] [NP a/DT collection/NN NP] PNP} [Prep of/IN Prep] [ADJP simple/JJ ADJP] ,/, [NP concise//NN guidelines/NNS NP] [NP which/WDT NP] [VP will/MD represent/VBP VP] [NP an/DT important/JJ first/JJ step/NN NP] [Prep in/IN Prep] [VP increasing/VBG VP] [NP your/PRP$ productivity/NN NP] {PNP [Prep as/IN Prep] [NP a/DT modeller//NN NP] PNP} ./.

3.4.1.4. Step 4—Definition Rules (LOOP1)

Definitions found:
1) The Elements of UML 2.0 Style describe a collection of standards, conventions, and guidelines for creating effective UML diagrams which are based on proven software engineering principles, easier to understand and work with. These conventions exist as a collection of simple, concise guidelines which will represent an important first step in increasing your productivity as a modeller. {DR1V3}
2) effective UML diagrams which are based on proven software engineering principles, easier to understand and work with. {DR1V2} {DR3}
3) concise guidelines which will represent an important first step in increasing your productivity as a modeller. {DR1V3} {DR3}
No Action found!

3.4.1.5. Step 5—Select Highest Scored DEF

Definition title:
effective <UML diagrams> {TR5FNP}
Definition description:
effective <UML diagrams> which are based on proven software engineering principles, easier to understand and work with. {DR4T1}
NOTE: this definition was chosen mainly because the title and the verb have high scores.

3.4.1.6. Step 6—Précis Text (Interim)

The Elements of UML 2.0 Style describe a collection of standards, conventions, and guidelines for creating effective <UML diagrams>. {PR2}{PR3}

3.4.1.7. Step 4—Definition Rules (LOOP2)

Definition found:
1) The Elements of UML 2.0 Style describe a collection of standards, conventions, and guidelines for creating effective <UML diagrams>. These conventions exist as a collection of simple, concise guidelines which will represent an important first step in increasing your productivity as a modeller. {DR1V3}
2) concise guidelines which will represent an important first step in increasing your productivity as a modeller. {DR1V3} {DR3}

3.4.1.8. Step 5—Select Highest Scored DEF

Definition title:

### The <Elements of UML 2.0 Style> {TR5HW}{TR5PL}

Definition description:
The <Elements of UML 2.0 Style> describe a collection of standards, conventions, conventions, and guidelines for creating effective <UML diagrams>. These conventions exist as a collection of simple, concise guidelines which will represent an important first step in increasing your productivity as a modeller. {DR4T1}{DR5}

3.4.1.9. Step 6—Précis Text (Interim)

The Elements of UML 2.0 Style describe a collection of standards, conventions, and guidelines for creating effective <UML diagrams>. These conventions exist as a collection of simple, concise guidelines which will represent an important first step in increasing your productivity as a modeller. {PR2}{PR3}

3.4.1.10. Step 4—Definition Rules (LOOP3)

Definition found:
1) concise guidelines which will represent an important first step in increasing your productivity as a modeller. {DR3}

3.4.1.11. Step 5—Select Highest Scored DEF

Definition title:
<concise guidelines>.
Definition description:
<concise guidelines> which will represent an important first step in increasing {DR4T2}

3.4.1.12. Step 6—Précis Text (Final)

These conventions exist as a collection of simple, <concise guidelines>. {PR2}{PR3}

### 4. Example

This example illustrates conditional actions {AR5} and scoring title according to sentence order {TR5PL}.

### 4.1. Original Text

A methodname is the name of a method that is defined by the object's type. If methodname is defined as a macro at the current point in the program, a warning will be issued.
We describe an often used measure in the information retrieval and natural language processing communities. The measure called the F-measure is a measure used to combine recall (r) and precision (p) with an equal weight. It is the harmonic mean of precision and recall.

### 4.2. Précis Text

If <methodname> is defined as a macro at the current point in the program, a warning will be issued.
We describe an often used measure in the information retrieval and natural language processing communities. The measure called the <F-measure>.

### 4.3. List Of Definitions

### <F-measure>

the F-measure is a measure used to combine recall (r) and precision (p) with an equal weight. It is the harmonic mean of precision and recall.

### <Methodname>

Methodname is the name of a method that is defined by the object's type.

### 4.4. Segments

4.4.1. First Segment

A methodname is the name of a method that is defined by the object's type. If methodname is defined as a macro at the current point in the program, a warning will be issued.

4.4.1.1. Step 1—Part-Of-Speech Tagging

Included in step 3 shallow parsing

4.4.1.2. Step 2—Acronym Search

### None

4.4.1.3. Step 3 Shallow Parsing

[C If/IN C] [NP methodname//PRP NP] [VP is/VBZ defined/VBN VP] {PNP [Prep as/IN Prep] [NP a/DT macro//NN NP] PNP} {PNP [Prep at/IN Prep] [NP the/DT current/JJ point/NN NP] PNP} {PNP [Prep in/IN Prep] [NP the/DT program/NN NP] PNP} ,/, [NP a/DT warning/NN NP] [VP will/MD be/VB issued/VBN VP]

4.4.1.4. Step 4—Definition Rules

Definition found:
1) A methodname is the name of a method that is defined by the object's type. {DR1V4}
Action found:
1) If methodname is defined as a macro at the current point in the program, a warning will be issued. {AR5}

4.4.1.5. Step 5—Select Highest Scored DEF

Definition title:
A <methodname>
Definition description:
A <methodname> is the name of a method that is defined by the objects type.

4.4.1.6. Step 6—Précis Text

If <methodname> is defined as a macro at the current point in the program, a warning will be issued: {PR2}{PR3}

4.4.2. Second Segment

We describe an often used measure in the information retrieval and natural language processing communities. The measure called the F-measure is a measure used to combine recall (r) and precision (p) with an equal weight. It is the harmonic mean of precision and recall.

4.4.2.1. Step 1—Part-of-Speech Tagging

Included in step 3 shallow parsing

4.4.2.2. Step 2—Acronym Search

### None

4.4.2.3. Step 3 Shallow Parsing

[NP We/PRP NP] [VP describe/VBP VP] [NP an/DT NP] [VP often/RB used/VBD VP] [NP measure/NN NP] {PNP [Prep in/IN Prep] [NP the/DT information/NN retrieval//NN NP] and/CC [NP natural/JJ language/NN processing/NN communities/NNS NP] PNP} ./.
[NP The/DT measure/NN NP] [VP called/VBD VP] [NP the/DT F-measure//NNP NP] [VP is/VBZ] [NP a/DT measure/NN NP] [VP used/VBN VP] [VP to/TO VP] [VP combine/VB recall/VB VP] (/( [NP r//NN NP] )/) and/CC [NP precision/NN NP] (/( [NP p/NN NP] )/) {PNP [Prep with/IN Prep] [NP an/DT equal/JJ weight/NN NP] PNP} ./. [NP It/PRP NP] [VP is/VBZ VP] [NP the/DT harmonic//NN NP] [VP mean/VB VP] {PNP [Prep of/IN Prep] [NP precision/NN and/CC recall/NN NP] PNP} ./.

4.4.2.4. Step 4—Definition Rules

Definition found:
1) the F-measure is a measure used to combine . . . {DR1V4}
No Action found!

4.4.2.5. Step 5—Select Highest Scored DEF

Definition title:

### the <F-measure> {TR5PL}

Definition description:
the <F-measure> is a measure used to combine recall (r) and precision (p) with an equal weight. It is the harmonic mean of precision and recall. {DR5}

4.4.2.6. Step 6—Précis Text

We describe an often used measure in the information retrieval and natural language processing communities. The measure called the <F-measure>. {PR2}{PR3}

### 5. Example

### 5.1. Original Text

The Standard Making Process (SMP) is the process applied for the technical organization of the production of standards and deliverables and the Secretariat involvement which is an involvement of Quality Management Systems (QMS).

### 5.2. Précis Text

The SMP is the process applied for the technical organization of the production of standards and deliverables and the <secretariat involvement>.

### 5.3. List of Definitions

<Secretariat involvement>
the Secretariat involvement which is an involvement of QMS.

### <Standards Making Process> (<SMP>)

The SMP is the process applied for the technical organization of the production of standards and deliverables and the Secretariat involvement which is an involvement of Quality Management Systems (QMS).

### 5.4. Segments

5.4.1. First Segment

The Standard Making Process (SMP) is the process applied for the technical organization of the production of standards and deliverables and the Secretariat involvement which is an involvement of Quality Management Systems (QMS).

5.4.1.1. Step 1—Part-of-Speech Tagging

The/DT Standard/NNP Making/VBG Process//NNP (/( SMP//NNP )/) is/VBZ the/DT process/NN applied/VBN for/IN the/DT technical/JJ organization/NN of/IN the/DT production/NN of/IN standards/NNS and/CC deliverables//NNS and/CC the/DT Secretariat//NN involvement/NN which/WDT is/VBZ an/DT involvement/NN of/IN Quality//NNP Management/NNP Systems/NNP (/( QMS//NNP )/)

5.4.1.2. Step 2—Acronym Search

### Step 2a Standard Making Process (SMP) {TR0}

Quality Management Systems (QMS) {TR0}

### Step 2b SMP/ACR QMS/ACR

5.4.1.3. Step 3 Shallow Parsing

[NP The/DT SMP/ ACR NP] [VP is/VBZ VP] [NP the/DT process/NN NP] [VP applied/VBN VP] {PNP [Prep for/IN Prep] [NP the/DT technical/JJ organization/NN of/IN the/DT production/NN NP] PNP} {PNP [Prep of/IN Prep] [NP standards/NNS NP] and/CC [NP deliverables//NNS NP] PNP} and/CC [NP the/DT Secretariat//NN involvement/NN NP] [NP which/WDT NP] [VP is/VBZ VP] [NP an/DT involvement/NN NP] {PNP [Prep of/IN Prep] [NP QMS/ ACR NP] PNP}.

5.4.1.4. Step 4—Definition Rules (LOOP1)

Definition found:
1) The SMP is the process . . . {DR1V4}
2) the Secretariat involvement which is an involvement of QMS. {DR1V4}{DR3}

5.4.1.5. Step 5—Select Highest Scored DEF

Definition title:

### The <SMP> {TR5AW}

Definition description:
The <SMP> is the process applied for the technical organization of the production of standards and deliverables and the Secretariat involvement which is an involvement of QMS.

5.4.1.6. Step 6—Précis Text (Interim)

The SMP is the process applied for the technical organization of the production of standards and deliverables and the Secretariat involvement which is an involvement of QMS.

5.4.1.7. Step 4—Definition Rules (LOOP2)

Definition found:
1) the Secretariat involvement which is an involvement of QMS. {DR1V4}{DR3}

5.4.1.8. Step 5—Select Highest Scored DEF

Definition title:
the <secretariat involvement> {TR5FNP}
Definition description:
the <secretariat involvement> which is an involvement of QMS

5.4.1.9. Step 6—Précis Text (Final)

The SMP is the process applied for the technical organization of the production of standards and deliverables and the <secretariat involvement>. {PR2}{PR3}

### 6. Example

According to the search steps given in {DR6}, if in the previous mentioned example the NP “The Standard Making Process” was not an acronym and on the contrary the NP “Secretariat involvement” was an acronym e.g. Secretariat involvement (SI) then the first selection made in step 5 (e.g. definition with the highest scored selection) would have been SI.

### 7. Example

### 7.1. Original Text

A license is defined as a permission to do something by which a licensee, a user given the permission to access and use the information under the terms and conditions described in the agreement of the licensor (a person or entity that gives or grants license), would be legal. The agreement (license agreement) is a written contract setting forth the terms under which a licensor grants a license to a licensee.

### 7.2. Précis Text

A license is defined as permission to do something by which a <licensee>, would be legal. The license agreement is a written contract setting forth the terms under which a <licensor> grants a <license> to a <licensee>.

### 7.3. List of Definitions

### <Licensee>

licensee, a user given the permission to access and use the information under the terms and conditions described in the agreement of the licensor (person or entity that gives or grants license), would be legal.

### <License>

License is defined as permission to do something by which a licensee, a user given the permission to access and use the information under the terms and conditions described in the agreement of the licensor (person or entity that gives or grants license), would be legal.
<License agreement>
The agreement (license agreement) is a written contract setting forth the terms under which a licensor grants a license to a licensee.

### <Licensor>

the licensor (a person or entity that gives or grants license),

### 7.4. Segments

7.4.1. First Segment

A license is defined as permission to do something by which a licensee, a user given the permission to access and use the information under the terms and conditions described in the agreement of the licensor (a person or entity that gives or grants license), would be legal. The agreement (license agreement) is a written contract setting forth the terms under which a licensor grants a license to a licensee.

7.4.1.1. Step 1—Part-Of-Speech Tagging

A/DT license//NNP is/VBZ defined/VBN as/IN permission/NN to/TO do/VB something/NN by/IN which/WDT a/DT licensee/NN ,/, a/DT user/NNP given/VBN the/DT permission/NN to/TO access/NN and/CC use/VB the/DT information/NN under/IN the/DT terms/NNS and/CC conditions/NNS described/VBN in/IN the/DT agreement/NN of/IN the/DT licensor//NN (/(a/DT person/NN or/CC entity/NN that/WDT gives/VBZ or/CC grants/VBZ license/NN )/) ,/, would/MD be/VB legal/JJ ./. The/DT agreement/NN (/( license/NN agreement/NN )/) is/VBZ a/DT written/VBN contract/NN setting/VBG forth/RB the/DT terms/NNS under/IN which/WDT a/DT licensor//NN grants/VBZ a/DT license/NN to/TO a/DT licensee/NN ./.

7.4.1.2, Step 2—Acronym Search

### None

7.4.1.3. Step 3 Shallow Parsing

[NP I A/DT license/NNP NP] [VP is/VBN defined/VBZ VP] {PNP [Prep as/IN Prep] [NP permission/NN NP] PNP} [VP to/TO do/VB VP] [NP something/NN NP] [Prep by/IN which/WDT Prep] ,/, [NP a/DT licensee/NN NP] ,/, [NP a/DT user/NNP NP] [VP given/VBN VP] [NP the/DT permission/NN NP] (PNP [Prep to/TO Prep] [NP access/NN NP] PNP} and/CC [VP use/VB VP] [NP the/DT information/NN NP] {PNP [Prep under/IN Prep] [NP the/DT terms/NNS and/CC conditions/NNS NP] PNP} [VP described/VBN VP] {PNP [Prep in/IN Prep] [NP the/DT agreement/NN NP] PNP} {PNP [Prep of/IN Prep] [NP the/DT licensor//NN NP] PNP} (/( [NP a/DT person/NN or/CC entity/NN NP] [NP that/WDT NP] [VP gives/VBZ or/CC grants/VBZ VP] [NP license/NN NP] )/) ,/, [VP would/MD be/VB VP] [ADJP illegal/JJ ADJP] ./.
[NP The/DT agreement/NN NP] (/( [NP license/NN agreement/NN NP] )/) [NP agreement/NN NP] )/) [VP is/VBZ VP] [NP a/DT written/VBN contract/NN NP] [VP setting/VBG VP] [ADVP forth/RB ADVP] [NP the/DT terms/NNS NP] [Prep under/IN Prep] [NP which/WDT NP] [NP a/DT NP] [NP licensor//NN NP] [VP grants/VBZ VP] [NP a/DT license/NN NP] {PNP [Prep to/TO Prep] [NP a/DT licensee/NN NP] PNP} ./.

7.4.1.4. Step 4—Definition Rules (LOOP1)

Definition found:

1) A license is defined as permission . . . {DR1V5}

2) licensee, a user given the permission to . . . {DR2}

3) the licensor (a person or entity that gives or grants license), {DR2}

4) The agreement (license agreement) is a written . . . {DR1V4}

7.4.1.5. Step 5—Select Highest Scored DEF

Definition title:
the <licensor> {TR5FNP} {TR5NH}
NOTE: This title (NP) is used frequently in the full original document that contains also this processed paragraph.
Definition description:
the <licensor> a person or entity that gives or grants license.

7.4.1.6. Step 6—Précis Text

A license is defined as permission to do something by which a licensee, a user given the permission to access and use the information under the terms and conditions described in the agreement of the <licensor>, would be legal. The agreement (license agreement) is a written contract setting forth the terms under which a licensor grants a license to a licensee. {PR2}{PR3}

7.4.1.7. Step 4—Definition Rules (LOOP2)

Definition found:

1) A license is defined as permission . . . {DR1V5}

2) licensee, a user given the permission to access . . . {DR2}

3) The agreement (license agreement) is a written . . . {DR1V4}

7.4.1.8. Step 5—Select Highest Scored DEF

Definition title:

### <Licensee> {TR5NH}

Definition description:
<Licensee>, a user given the permission to access and use the information under the terms and conditions described in the agreement of the <licensor>.

7.4.1.9. Step 6—Précis Text (Interim)

A license is defined as permission to do something by which a <licensee>, would be legal. The agreement (license agreement) is a written contract setting forth the terms under which a <licensor> grants a license to a <licensee>. {PR2}{PR3}

7.4.1.10. Step 4—Definition Rules (LOOP3)

Definition found:
1) A license is defined as permission . . . {DR1V5}
2) The agreement (license agreement) is a written . . . {DR1V4}

.7.4.1.11. Step 5—Select Highest Scored DEF

Definition title:

### <License> {TR5HW}

Definition description:
<License> defines as permission to do something which, without <licensee>, would be illegal. {DR4T1}

7.4.1.12. Step 6—Précis Text (Interim)

A license is defined as permission to do something by which a <licensee>, would be legal. The agreement (license agreement) is a written contract setting forth the terms under which a licensor grants a <license> to a <licensee>. {PR2}{PR3}

7.4.1.13. Step 4—Definition Rules (LOOP4)

Definition found:

1) The agreement (license agreement) is a written . . . {DR1V4}

7.4.1.14. Step 5—Select Highest Scored DEF

Definition title:
The <license agreement> {TR3}
Definition description:
The <license agreement> is a written contract setting forth the terms under which a licensor grants a license to a licensee.

7.4.1.15. Step 6—Précis Text (Final)

A license is defined as permission to do something by which a <licensee>, would be legal. The license agreement is a written contract setting forth the terms under which a <licensor> grants a <license> to a <licensee>.

### 8. Example

### 8.1. Original Text

Insurance contract or policy means each general insurance contract arising out of or in connection with an insurance business between an insurer and a consumer.
Insurance business means:
(1) contracts of insurance which are prescribed contracts under section 34 of the Insurance Contracts Act 1984. These contracts are described in the Insurance Contracts Regulations as: home contents, sickness and accident, consumer credit, travel etc.
(2) contracts of insurance which insure personal and domestic property (including movables, valuables, caravans, on-site mobile homes and marine pleasure craft).

### 8.2. Précis Text

Insurance business means:
(1)<contracts of insurance> which are prescribed contracts under section 34 of the Insurance Contracts Act 1984. These contracts are described in the Insurance Contracts Regulations as: home contents, sickness and accident, consumer credit, travel etc.
(2)<contracts of insurance> which insure personal and domestic property (including movables, valuables, caravans, on-site mobile homes and marine pleasure craft).

### 8.3. List of Definitions

<Insurance business>
Insurance business means
(1) contracts of insurance which are prescribed contracts under section 34 of the Insurance Contracts Act 1984. These contracts are described in the Insurance Contracts Regulations as: home contents, sickness and accident, consumer credit, travel etc.
(2) contracts of insurance which insure personal and domestic property (including movables, valuables, caravans, on-site mobile homes and marine pleasure craft).
<Insurance contract>
Insurance contract or policy means each general insurance contract arising out of or in connection with an insurance business between an insurer and a consumer.
<contracts of insurance>==<Insurance contract >

### 8.4. Segments

8.4.1. First Segment

Insurance contract or policy means each general insurance contract arising out of or in connection with an insurance business between an insurer and a consumer. Insurance business means:
(1) contracts of insurance which are prescribed contracts under section 34 of the Insurance Contracts Act 1984. These contracts are described in the Insurance Contracts Regulations as: home contents, sickness and accident, consumer credit, travel etc.
(2) contracts of insurance which insure personal and domestic property (including movables, valuables, caravans, on-site mobile homes and marine pleasure craft).

8.4.1.1. Step 1—Part-of-Speech Tagging

Insurance/NN contract/NN or/CC policy/NN means/VBZ each/DT general/JJ insurance/NN contract/NN arising/VBG out/IN of/IN or/CC in/IN connection/NN with/IN an/DT insurance/NN business/NN between/IN an/DT insurer/NN and/CC a/DT consumer/NN ;/: Insurance/NN business/NN means/VBZ (/( 1/LS )/) contracts/NNS of/IN insurance/NN which/WDT are/VBP prescribed/VBN contracts/NNS under/IN section/NN 34/CD of/IN the/DT Insurance/NNP Contracts//NNPS Act/NNP 1984/CD ./.
These/DT contracts/NNS are/VBP described/VBN in/IN the/DT Insurance/NNP Contracts//NNPS Regulations//NNP as/IN :/: home/NN contents/NNS ,/, sickness//NN and/CC accident/NN ,/, consumer/NN credit/NN ,/, travel/VBP etc./FW (/( 2/LS .)/) contracts/NNS of/IN insurance/NN which/WDT insure/VBP personal/JJ and/CC domestic/JJ property/NN (/( including/VBG movables//NNS ,/, valuables//NNS ,/, caravans//NNS ,/, on-site/JJ mobile/JJ homes/NNS and/CC marine/JJ pleasure/NN craft/NN )/)./.

8.4.1.2. Step 2—Acronym Search

### None

8.4.1.3. Step 3 Shallow Parsing

[NP Insurance/NN contract/NN or/CC policy/NN NP] [VP means/VBZ VP] [NP each/DT general/JJ insurance/NN contract/NN NP] [VP arising/VBG VP] [Prep out/IN Prep] [Prep of/IN Prep] or/CC {PNP [Prep in/IN Prep] [NP connection/NN NP] PNP} {PNP [Prep with/IN Prep] [NP an/DT insurance/NN business/NN NP] PNP} (PNP [Prep between/IN Prep] [NP an/DT insurer/NN and/CC a/DT consumer/NN NP] PNP} ;/: [NP Insurance/NN business/NN NP] [VP means/VBZ VP]
(/( [LST 1/LS LST] )/) [NP contracts/NNS NP] {PNP [Prep of/IN Prep] [NP insurance/NN NP] PNP} [NP which/WDT NP] [VP are/VBP prescribed/VBN VP] [NP contracts/NNS NP] {PNP [Prep under/IN Prep] [NP section/NN NP] PNP} [NP 34/CD NP] {PNP [Prep of/IN Prep] [NP the/DT. Insurance/NNP Contracts//NNPS Act/NNP 1984/CD NP] PNP} ./. [NP These/DT contracts/NNS NP] [VP are/VBP described/VBN VP] {PNP [Prep in/IN Prep] [NP the/DT Insurance/NNP Contracts//NNPS Regulations//NNP NP] PNP} {PNP [Prep as/IN Prep] :/: [NP home/NN contents/NNS NP] PNP} ,/, [NP sickness//NN and/CC accident/NN ,/, consumer/NN credit/NN NP] ,/, [VP travel/VBP VP] [NP etc./FW NP] (/( [LST 2/LS LST] )/) [NP contracts/NNS NP] {PNP [Prep of/IN Prep] [NP insurance/NN NP] PNP} [NP which/WDT NP] [VP insure/VBP VP] [NP personal/JJ and/CC domestic/JJ property/NN NP] (/( {PNP [Prep including/VBG Prep] [NP movables//NNS NP] PNP} ,/, [NP valuables//NNS NP] ,/, [NP caravans//NNS NP] ,/, [NP on-site/JJ mobile/JJ homes/NNS NP] and/CC [NP marine/JJ pleasure/NN craft/NN NP] )/) ./.

8.4.1.4. Step 4—Definition Rules (LOOP1)

Definition found:
1) Insurance contract or policy means each general . . . {DR1V4}
2) Insurance business means . . . {DR1V4}

8.4.1.5. Step 5—Select Highest Scored DEF

Definition title:
<Insurance contract> or policy {TR5FNP}{TR2}
<contracts of insurance> {TR3}
Definition description:
<Insurance contract> or policy means each general insurance contract arising out of or in connection with an insurance business between an insurer and a consumer {DR4T1}

8.4.1.6. Step 6—Précis Text (Interim)

Insurance business means:
(1)<contracts of insurance> which are prescribed contracts under section 34 of the Insurance Contracts Act 1984. These contracts are described in the Insurance Contracts Regulations as: home contents, sickness and accident, consumer credit, travel etc.
(2)<contracts of insurance> which insure personal and domestic property (including movables, valuables, caravans, on-site mobile homes and marine pleasure craft). {PR2}{PR3}

8.4.1.7. Step 4—Definition Rules (LOOP2)

Definition found:
1) Insurance business means . . . {DR1V4}

8.4.1.8. Step 5—Select Highest Scored DEF

Definition title:
<Insurance business> {TR5HW}
Definition description:
<Insurance business means>:
1)<contracts of insurance> which are prescribed contracts under section 34 of the Insurance Contracts Act 1984. These contracts are described in the Insurance Contracts Regulations as: home contents, sickness and accident, consumer credit, travel etc.
(2)<contracts of insurance> which insure personal and domestic property (including movables, valuables, caravans, on-site mobile homes and marine pleasure craft). {DR4T1}

8.4.1.9. Step 6—Précis Text (Final)

Insurance business means:
(1)<contracts of insurance> which are prescribed contracts under section 34 of the Insurance Contracts Act 1984. These contracts are described in the Insurance Contracts Regulations as: home contents, sickness and accident, consumer credit, travel etc.
(2)<contracts of insurance> which insure personal and domestic property (including movables, valuables, caravans, on-site mobile homes and marine pleasure craft).

### 9. Search Engine Example

In the search results based on definitions we show possible search output that can be either shortened or extended e.g. less definitions or shorter précis text.

### 9.1. Selected Search Words

Word searched: “National Insurance”

### 9.2. Existing Web Search Engine

One of the known web search engine result:
National insurance-contributions and benefits
Information on national insurance contributions including classes of contributions, contribution conditions for benefits and how to get a national insurance . . . .
www.adviceguide.org.uk/nm/index/life/benefits/national_insurance_contributions_a nd_benefits.htm-64k

### 9.3. Search Result Based On Definitions

National insurance-contributions and benefits
<National insurance> is a scheme where people in work make payments towards benefits.
<National insurance number (NINO)> is a number unique to you which is used to keep track of your <national insurance> contributions.
<National insurance number card> (NINO card) is not proof of your identity; it is just a reminder of your national insurance number.
www.adviceguide.org.uk/nm/index/life/benefits/national_insurance_contributions_a nd_benefits.htm-64k

### 9.4. Search Result Based On Précis Text

National insurance-contributions and benefits
The payments are called <national insurance contributions> and certain benefits are only payable if you meet the <national insurance contribution> conditions.
<National insurance contributions> also go towards the costs of the National Health Service. The <national insurance scheme> is administered by the HM Revenue and Customs (HMRC).
If you are a young person under 16 living in the UK, and your parent gets Child

Benefit for you, you will automatically be registered for <national insurance>, and a <national insurance card> showing your number will be sent to you just before your 16th birthday.

www.adviceguide.org.uk/nm/index/fife/benefits/national_Insurance_contributions_a nd_benefits.htm-64k

What is claimed is:

1. A method for organizing definitions in documents, said method comprising the steps of:
scanning segment of texts in said document for definition candidates according to definition rules;
scoring each definition candidate according to its correspondence to said definition rules;
selecting definition candidates with highest scores;
searching for nested definitions for each said segment of text, wherein said segment of text includes at least one definition candidate.

2. The method of claim 1 wherein said definition rules are comprised of at least one of the following: syntactic analysis of phrases, keywords identification, analysis of typographic phrase formatting.

3. The method of claim 2 wherein said syntactic analysis comprises the steps of
identifying the tense of said phrase;
identifying grammatical characteristics of said phrase.

4. The method of claim 3 wherein said grammatical characteristics include at least one of the following: identifying indicative verbs, identifying indicative phrase components, identifying part of speech, identifying indicative of said segment of text.

5. The method of claim 1 wherein said scoring of definitions are weighted using at least one of the following methods: manually, automatically.

6. The method of claim 5 wherein in said automatic method the rules are scored by analyzing existing definitions and extracting the most prevalent definitions phrasing style.

7. The method of claim 6 wherein said existing definitions are comprised of at least one of the following: document containing definition candidates, document containing definitions, a definitions library.

8. The method of claim 1 further comprising the step of associating a definition title to each selected definition.

9. The method of claim 8 wherein the process of extracting said definition title further comprises the steps of:
searching for all noun phrases in said definition;
assigning a score to each noun phrase;
selecting the noun phrase with the highest score as the definition title.

10. The method of claim 9 wherein said scoring noun phrase is comprised of at least one of the following: sentence order, location of the noun phrase in the sentence, noun phrases frequency across different sentences, noun phrase words content, syntactic pattern, acronym, name entity.

11. The method of claim 9 wherein said scoring of noun phrase is performed by giving weight to title rule.

12. The method of claim 9 wherein said scoring of noun phrase is performed using at least one of the following methods: manually, automatically.

13. The method of claim 12 wherein in said automatic method rules are scored by analyzing existing title and extracting the most prevalent title phrasing style.

14. The method of claim 1 further including the step of creating a list of all definition candidates including the definition title and the definition description.

15. The method of claim 1 further including the step of extracting a précis of said texts wherein said précis is a shorter presentation of the original text in which each identified definition is replaced with its definition title.

16. The method of claim 15 wherein the process of extracting said précis includes the steps of:
searching for all definition candidates;
creating a list of all definitions including definition title and definition description;
replacing each definition description by its definition title to create said précis;
making grammatical corrections in said précis.

17. The method of claim 1 further comprising the step of creating an index in offline mode, by processing data communication network content pages, wherein for each content page said index contains a list of definitions, definition titles and précis text;

18. The method of claim 17 further comprising the steps of enabling the users to conduct searches in said index through a dedicated user interface and displaying to the users at least partial search results.

19. The method of claim 18 wherein said displaying includes one of the following: definitions list, précis text.

20. The method of claim 1 further comprising the step of measuring the efficiency and consistency of said texts according to the reuse of definitions in at least one document.

21. The method of claim 20 wherein said documents are organized in a hierarchical structure, wherein child documents inherit parent document definition candidates.

22. The method of claim 1 further comprising the step of automatically compiling a definitions index.

23. The method of claim 1 wherein said definition organization provides users with learning methodologies.

24. The method of claim 1 further comprising the step of evaluating thinking patterns in pattern perception evaluation skills tests on the basis of definition organization.

25. The method of claim 1 wherein said definition is in the form of at least one of the following: text, table, formula, image, figure, text data, flowchart, video clip, hypertext link, Extensible Markup Language (XML) text.

26. The method of claim 1 further comprising the step of providing the user with online definition suggestions during the editing of said text.

27. The method of claim 1 further including the step of evaluating said text document in accordance with the number of identified definitions in relations to the length of said text document.
